(19) United States
(12) Patent Application Publication
(10) Pub. No.: US 2009/0219591 A1
(43) Pub. Date: Sep. 3, 2009

(54) METHODS AND APPARATUS FOR DISPLAYING COLOUR IMAGES USING HOLOGRAMS

(75) Inventor: Adrian James Cable, Cambridgeshire (GB)

Correspondence Address: KNOBBE MARTENS OLSON & BEAR LLP, 2040 MAIN STREET, FOURTEENTH FLOOR, IRVINE, CA, 92614, US

(73) Assignee: Light Blue Optics Ltd., Cambridge, Cambridgeshire (GB)

(21) Appl. No.: 12/303,096

(22) PCT Filed: May 23, 2007
(86) PCT No.: PCT/GB07/50291

§ 371 Date: Mar. 31, 2009

(30) Foreign Application Priority Data
Jun. 2, 2006 (GB) 0610784.1

(51) Int. Cl. G03H 1/08

(52) U.S. Cl. 359/9

(57) ABSTRACT

We describe a method of projecting a colour image on a screen holographically. The method includes: inputting colour image data including data for at least two colour planes of said image, a first, longer wavelength colour plane and a second, shorter wavelength colour plane; generating data for respective first and second holograms from said first and second colour planes, said first hologram having a greater resolution than said second hologram; and displaying said first and second holograms in turn on a common spatial light modulator (SLM) illuminated by light of respective said first and second wavelengths to project said colour image onto said screen; and wherein a scaling in resolution between said first and second holograms is dependent on scaling between said first and second wavelengths such that, when projected on said screen pixels of said image generated by said first and second holograms have substantially the same pitch.

### CROSS-REFERENCE TO RELATED APPLICATIONS

This application is the U.S. National Phase under 35 U.S.C. § 371 of International Application No. PCT/GB2007/050291, filed May 23, 2007, designating the United States and published in English on Dec. 13, 2007, as WO 2007/141567, which claims priority to United Kingdom Application No. 0610784.1, filed Jun. 2, 2006.

### FIELD OF THE INVENTION

This invention relates to colour holographic projector systems, more particularly to methods, apparatus and computer program code for projecting an image onto a screen using holography.

### BACKGROUND TO THE INVENTION

Many small, portable consumer electronic devices incorporate a graphical image display, generally a LCD (Liquid Crystal Display) screen. These include digital cameras, mobile phones, personal digital assistants/organisers, portable music devices such as the iPOD (trade mark), portable video devices, laptop computers and the like. In many cases it would be advantageous to be able to provide a larger and/or projected image but to date this has not been possible, primarily because of the size of the optical system needed for such a display.

Therefore we have previously described, in UK patent application number 0512179.3 filed 15 Jun. 2005, incorporated by reference, a holographic projection module comprising a substantially monochromatic light source such as a laser diode; a spatial light modulator (SLM) to (phase) modulate the light to provide a hologram for generating a displayed image; and a demagnifying optical system to increase the divergence of the modulated light to form the displayed image. The size of a displayed image depends on the pixel size of the SLM, smaller pixels diffracting the light more to produce a larger image; the demagnifying optics increase the diffraction, thus allowing an image of a larger size to be displayed at a given distance. The displayed image is substantially focus-free: that is the image is substantially in focus over a wide range or at all distances from the projection module.

The techniques we describe may be employed with any type of system or procedure for calculating a hologram to display on the SLM in order to generate the displayed image. However we have some particularly preferred procedures (described below) in which the displayed image is formed from a plurality of holographic sub-images which visually combine to give (to a human observer) the impression of the desired image for display. Thus, for example, these holographic sub-frames are preferably temporally displayed in rapid succession so as to be integrated within the human eye. The data for successive holographic sub-frames may be generated by a digital signal processor, which may comprise either a general purpose DSP under software control, for example in association with a program stored in non-volatile memory, or dedicated hardware, or a combination of the two such as software with dedicated hardware acceleration. Preferably the SLM comprises a reflective SLM (for compactness) but in general any type of pixellated microdisplay which is able to phase modulate light may be employed, optionally in association with an appropriate driver chip if needed.

Referring now to FIG. 1, this shows an example a consumer electronic device 10 incorporating a hardware projection module 12 to project a displayed image 14. Displayed image 14 comprises a plurality of holographically generated sub-images each of the same spatial extent as displayed image 14, and displayed rapidly in succession so as to give the appearance of the displayed image. Each holographic sub-frame is generated along the lines described below. For further details reference may be made to GB 0329012.9 (ibid).

FIG. 2 shows an example optical system for the holographic projection module of FIG. 1. Referring to FIG. 2, a laser diode 20 (for example, at 532 nm), provides substantially collimated light 22 to a spatial light modulator 24 such as a pixellated liquid crystal modulator. The SLM 24 phase modulates light 22 with a hologram and the phase modulated light is provided to a demagnifying optical system 26. In the illustrated embodiment, optical system 26 comprises a pair of lenses 28, 30 with respective focal lengths f₁, f₂, f₁<f₂, spaced apart at distance f₁+f₂. Optical system 26 (which is not essential) increases the size of the projected holographic image by diverging the light forming the displayed image, as shown.

It is, however, particularly desirable to be able to project colour images holographically, especially for consumer applications.

### SUMMARY OF THE INVENTION

According to a first aspect of the present invention there is therefore provided a method of projecting a colour image on a screen holographically the method comprising: inputting colour image data comprising data for at least two colour planes of said image, a first, longer wavelength colour plane and a second, shorter wavelength colour plane; generating data for respective first and second holograms from said first and second colour planes of said colour image data, said first hologram having a greater resolution than said second hologram; and displaying said first and second holograms in turn on a common spatial light modulator (SLM) illuminated by light of respective said first and second wavelengths to project said colour image onto said screen; and wherein a scaling in resolution between said first and second holograms is dependent on scaling between said first and second wavelengths such that, when projected on said screen pixels of said image generated by said first and second holograms have substantially the same pitch.

Broadly speaking, the inventors have recognised that the number points into which the total image field is divided is determined by the number of points in the hologram, although the size of the image field is determined by the wavelength of the replay light and the size of the SLM pixels. Thus by using more points in the hologram plane (on the SLM) for longer wavelengths, say red, the number of pixels on the display screen is increased, albeit that for the red image these extend over a larger area. By choosing the increased resolution to compensate for the increased extent of the total field size the same spacing between pixels may be achieved for two different replay wavelengths, for example red and blue. It will be recognised that an intermediate wavelength, such as green, may be treated similarly. (In embodiments of the above described method the references to a longer wavelength colour plane and to a shorter wavelength colour plane merely label how the colour plane is to be used for replay rather than defining a precise wavelength—for example a “red” colour plane may be replayed using, say, green light.)

In some preferred embodiments of the method an initial input image is padded with fixed data, for example zeros, to increase the extent of the image plane (without increasing the number of “image information bearing” pixels). More particularly the different wavelength colour planes, for example red, green and blue colour planes, are padded differently in order to scale the relative extents of the different image planes according to wavelength so that when the holographic transform procedure, preferably an OSPR-type procedure, is employed the holograms resulting are scaled in proportion to wavelength in preparation for display on the SLM. This padding may be performed so that the longer wavelength colour plane extends to a number of pixels, at least in one dimension, provided by the SLM. In other words, preferably the longer wavelength colour plane is extended to substantially fill, as far as possible, the SLM.

However in embodiments, since the eye is particularly sensitive to green, a green image plane may contribute most to a perceived resolution of the displayed image and therefore, when a colour image plane is being extended, the green image may be scaled so as to fit within the SLM, tolerating some loss in red resolution. More generally the above procedure (and those described below) may employ a scaling in which green resolution is increased at the expense of the resolution of a longer wavelength, for example red.

In another aspect the invention provides a method of projecting a colour image on a screen holographically the method comprising: inputting colour image data comprising data for at least two colour planes of said image, a first, longer wavelength colour plane and a second, shorter wavelength colour plane; upsizing said second colour plane in proportion to a ratio of said longer to said shorter wavelength to increase a number of image pixels in said second colour plane; generating data for respective first and second holograms from said first and second colour planes of said colour image data; and displaying said first and second holograms in turn on a common spatial light modulator (SLM) illuminated by light of respective said first and second wavelengths to project said colour image onto said screen; and wherein said upsizing is such that, when projected on said screen, pixels of said first and second colour planes in said input image have substantially the same pitch.

Broadly speaking, in embodiments of this aspect of the invention, rather than increasing the resolution of the longer wavelength, say red, hologram plane so that, when displayed, the red pixel pitch corresponds to the other colour(s) the resolution of each of the hologram planes is substantially the same. Thus on the display screen pixels generated by the blue hologram plane are smaller than pixels generated by the red hologram plane. To compensate for this the shorter wavelength, say blue, colour plane is upsized prior to generation of its corresponding hologram(s) to compensate for this. More particularly the shorter wavelength colour plane(s) are upsized in inverse proportions to their replay wavelength, more particularly in proportion to a ratio of the longer to shorter replay wavelengths. This upsizing comprises increasing the number of image information bearing pixels in the relevant colour plane rather than merely padding around the image to increase an extent of the image plane. This upsizing may be performed in a number of different ways including, but not limiting to, interpolation, use of an FIR (finite impulse response) filter and the like.

An advantage of embodiments of this approach, as compared with embodiments of the first aspect of the invention as described above, is that all the holographic transforms are of the same size. Furthermore the scaling can be selected so that the size of an image plane to which holographic transformation is applied is a number which facilitates hardware or software processing, for example a power of 2, a multiple of 4, 8 or 16, or the like. In embodiments of the method, as well as upsizing the input image colour planes may also be padded, for example, so that an extent of a processed image plane, and hence a hologram plane, matches, at least in one dimension, a spatial extent of the SLM in terms of a number of pixels.

Again the skilled person will understand that embodiments of the above-described method according to the second aspect of the invention, three colour planes, typically red, green and blue, are processed.

In a still further aspect of the invention there is provided a method of generating a colour holographic image, the method employing a common spatial light modulator (SLM) to modulate at least two different colour components of said image, said SLM having a plurality of pixels modulated to display a hologram, said hologram reconstructing to display on a screen a pixellated image for each said colour component, the method comprising: inputting data for an image to be displayed, said image data comprising data for first and second colour components of said image, said second colour component having a longer wavelength than said first colour component; increasing a number of image information bearing pixels of said first colour component of said input image or a number of pixels of a holographic transform of said second colour component of said input image such that when displayed on said screen pixels of said first and second colour components of said input image having substantially the same size; and generating said colour holographic image using said increased resolution component.

As previously mentioned, preferably the screen comprises a two-dimensional screen.

Preferably in embodiments of all the above-described methods an OSPR-type procedure is employed to generate the holograms displayed on the SLM, thus employing a plurality of temporal holographic sub-frames to generate each colour plane of a displayed image frame. The skilled person will recognise that the display of the different wavelengths, for example red, green and blue is preferably time multiplexed, and the temporal subframes may either be displayed for each colour plane in turn, or interleaved between different colour planes.

The invention further provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a related aspect the invention provides apparatus for projecting a colour image on a screen holographically, the apparatus comprising: means for inputting colour image data comprising data for at least two colour planes of said image, a first, longer wavelength colour plane and a second, shorter wavelength colour plane; means for generating data for respective first and second holograms from said first and second colour planes of said colour image data, said first hologram having a greater resolution than said second hologram; and means for displaying said first and second holograms in turn on a common spatial light modulator (SLM) illuminated by light of respective said first and second wavelengths to project said image onto said screen; and wherein a scaling in resolution between said first and second holograms is dependent on a scaling between said first and second wavelengths such that, when projected on said screen pixels of said image generated by said first and second holograms have substantially the same pitch.

The invention further provides apparatus for projecting a colour image on a screen holographically, the apparatus comprising: means for inputting colour image data comprising data for at least two colour planes of said image, a first, longer wavelength colour plane and a second, shorter wavelength colour plane; means for upsizing said second colour plane in proportion to a ratio of said longer to said shorter wavelength to increase a number of image pixels in said second colour plane; means for generating data for respective first and second holograms from said first and second colour planes of said colour image data; means for displaying said first and second holograms in turn on a common spatial light modulator (SLM) illuminated by light of respective said first and second wavelengths to project said colour image onto said screen; and wherein said upsizing is such that, when projected on said screen, pixels of said first and second colour planes in said input image have substantially the same pitch.

The invention still further provides apparatus for generating a colour holographic image, the apparatus employing a common spatial light modulator (SLM) to modulate at least two different colour components of said image, said SLM having a plurality of pixels modulated to display a hologram, said hologram reconstructing to display on a screen a pixellated image for each said colour component, the apparatus comprising; means for inputting data for an image to be displayed, said image data comprising data for first and second colour components of said image, said second colour component having a longer wavelength than said first colour component; means for increasing a number of image information bearing pixels of said first colour component of said input image or a number of pixels of a holographic transform of said second component of said input image such that when displayed on said screen pixels of said first and second colour components of said input image have substantially the same size; and means for generating said colour holographic image using said increased resolution component.

The invention still further provides a colour holographic image projection module, the module comprising: light sources configured to provide collimated light beams of at least two different colours; combining optics to combine said optical paths from said light sources into a single combined optical path; a spatial light modulator in said combined optical path to modulate light from said light sources; and demagnifying optics following said spatial light modulator in said combined optical path; and wherein said illuminated light beams have different cross-sectional areas.

In embodiments the light sources comprise substantially monochromatic light sources, such as laser diodes. The combining optics may comprise, for example, dichroic beam splitters, or may be implemented using a range of other optical techniques, as will be understood by those skilled in the art.

In some embodiments the lateral dimensions or areas of the columimated light beams are dependent upon a ratio of respective wavelengths of the light sources, more particularly substantially in proportion to a ratio of respective wavelengths of the light sources. Additionally or alternatively amplitudes or intensities of the columimated light beams may depend upon a ratio of wavelengths of the light sources, more particularly may be arranged to be substantially in proportion to a ratio of wavelength of the light sources, for example to compensate for the different spatial extents of the display fields, in particular in embodiments of the methods according to the second aspect of the invention as described above.

The above described aspects of the invention, and features of the above described aspects may be combined in any permutation.

The invention further provides a consumer electronic device, in particular a portable device, including a holographic image projection system or optical module as described above.

### BRIEF DESCRIPTION OF THE DRAWINGS

These and other aspects of the invention will now be further described, by way of example only, with reference to the accompanying figures in which:

FIG. 1 shows an example of a consumer electronic device incorporating a holographic projection module;

FIG. 2 shows an example of an optical system for the holographic projection module of FIG. 1;

FIG. 3 shows a block diagram of an embodiment of a hardware accelerator for the holographic image display system of FIGS. 1 and 2;

FIG. 4 shows the operations performed within an embodiment of a hardware block as shown in FIG. 3;

FIG. 5 shows the energy spectra of a sample image before and after multiplication by a random phase matrix.

FIG. 6 shows an embodiment of a hardware block with parallel quantisers for the simultaneous generation of two sub-frames from the real and imaginary components of the complex holographic sub-frame data respectively.

FIG. 7 shows an embodiment of hardware to generate pseudo-random binary phase data and multiply incoming image data, I_{xy}, by the phase values to produce G_{xy}.

FIG. 8 shows an embodiment of hardware to multiply incoming image frame data, I_{xy}, by complex phase values, which are randomly selected from a look-up table, to produce phase-modulated image data, G_{xy};

FIG. 9 shows an embodiment of hardware which performs a 2-D transform on incoming phase-modulated image data, G_{xy}, by means of a 1-D transform block with feedback, to produce holographic data gᵤᵥ;

FIG. 10 shows a colour holographic image projection system according to an embodiment of the invention;

FIG. 11 shows image, hologram (SLM) and display screen planes for an embodiment of a first aspect of the invention; and

FIG. 12 shows image, hologram (SLM) and display screen planes for an embodiment of a second aspect of the invention.

### DETAILED DESCRIPTION OF PREFERRED EMBODIMENTS

Referring again to FIG. 2, in more detail lenses L₁ and L₂ (with focal lengths f₁ and f₂ respectively) form the beam-expansion pair. This expands the beam from the light source so that it covers the whole surface of the modulator. The skilled person will understand that depending on the relative size of the beam 22 and SLM 24 this may be omitted.

Lens pair L₃ and L₄ (with focal lengths f₃ and f₄ respectively) form a demagnification lens pair, in effect a demagnifying telescope. This effectively reduces the pixel size of the modulator, thus increasing the diffraction angle. As a result, the image size increases. The increase in image size is equal to the ratio of f₃ to f₄, which are the focal lengths of lenses L₃ and L₄ respectively. The skilled person will understand that other optical arrangements can also be used to achieve this effect. In embodiments a filter may also be included to filter out unwanted parts of the displayed image, for example a bright (zero order) undiffracted spot or a repeated first order image, which may appear as an upside down version of the displayed image, depending upon how the hologram for displaying the image is generated.

In one particularly preferred implementation at least one lens is encoded in the hologram, thus allowing the size of the optical system to be reduced. This is described in UK patent application GB 0606123.8 filed on 28 Mar. 2006, hereby incorporated by reference in its entirety. The lens which is encoded in the hologram preferably comprises a lens which, in a conventional configuration, would be adjacent the hologram, such as lens L₂ or lens L₃ of FIG. 2. Thus this lens may comprise a collimation lens (collimation optics) of the first optics, for example forming part of a beam expander or Keplerian telescope and/or a lens of demagnification optics for the hologram.

Continuing to refer to FIG. 2, a digital signal processor 100 has an input 102 to receive image data from the consumer electronic device defining the image to be displayed. The DSP 100 implements a procedure (described below) to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14 in the replay field (RPF).

The DSP 100 may comprise dedicated hardware and/or Flash or other read-only memory storing processor control code to implement a hologram generation procedure, in preferred embodiments in order to generate sub-frame phase hologram data for output to the SLM 24.

### OSPR

We now describe a preferred procedure for calculating hologram data for display on SLM 24. We refer to this procedure, in broad terms, as One Step Phase Retrieval (OSPR), although strictly speaking in some implementations it could be considered that more than one step is employed (as described for example in GB0518912.1 and GB0601481.5, incorporated by reference, where “noise” in one sub-frame is compensated in a subsequent sub-frame).

Thus we have previously described, in UK Patent Application No. GB0329012.9, filed 15 Dec. 2003, a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms.

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and π (+1 and −1 for a normalised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image frames within a limited frame period.

We have also described, in GB0511962.3, filed 14 Jun. 2005, a hardware accelerator for a holographic image display system, the image display system being configured to generate a displayed image using a plurality of holographically generated temporal sub-frames, said temporal sub-frames being displayed sequentially in time such that they are perceived as a single reduced-noise image, each said sub-frame being generated holographically by modulation of a spatial light modulator with holographic data such that replay of a hologram defined by said holographic data defines a said sub-frame, the hardware accelerator comprising: an input buffer to store image data defining said displayed image; an output buffer to store holographic data for a said sub-frame; at least one hardware data processing module coupled to said input data buffer and to said output data buffer to process said image data to generate said holographic data for a said sub-frame; and a controller coupled to said at least one hardware data processing module to control said at least one data processing module to provide holographic data for a plurality of said sub-frames corresponding to image data for a single said displayed image to said output data buffer.

In this preferably a plurality of the hardware data processing modules is included for processing data for a plurality of the sub-frames in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile data store. The phase modulator preferably includes at least one multiplier to multiply pixel data from the input data buffer by input phase modulation data. In a simple embodiment the multiplier simply changes a sign of the input data.

An output of the phase modulator is provided to a space-frequency transformation module such as a Fourier transform or inverse Fourier transform module. In the context of the holographic sub-frame generation procedure described later these two operations are substantially equivalent, effectively differing only by a scale factor. In other embodiments other space-frequency transformations may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transform of the (spatial distribution of the) phase modulated image data to output holographic sub-frame data. This simplifies the hardware and enables processing of, for example, first rows then columns (or vice versa).

In preferred embodiments the hardware also includes a quantiser coupled to the output of the transformation module to quantise the holographic sub-frame data to provide holographic data for a sub-frame for the output buffer. The quantiser may quantise into two, four or more (phase) levels. In preferred embodiments the quantiser is configured to quantise real and imaginary components of the holographic sub-frame data to generate a pair of sub-frames for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of sub-frames the less the overall noise this provides further benefits.

Preferably one or both of the input and output buffers comprise dual-ported memory. In some particularly preferred embodiments the holographic image display system comprises a video image display system and the displayed image comprises a video frame.

In an embodiment, the various stages of the hardware accelerator implement a variant of the algorithm given below, as described later. The algorithm is a method of generating, for each still or video frame I=I_{xy}, sets of N binary-phase holograms h⁽¹⁾ . . . h^{(N)}. Statistical analysis of the algorithm has shown that such sets of holograms form replay fields that exhibit mutually independent additive noise.
1. Let G_{xy}⁽ⁿ⁾=I_{xy}exp(jφ_{xy}⁽ⁿ⁾) where φ_{xy}⁽ⁿ⁾ is uniformly distributed between 0 and 2π for 1≦n≦N/2 and 1≦x,y≦m
2. Let gᵤᵥ⁽ⁿ⁾=F⁻¹[G_{xy}⁽ⁿ⁾] where F⁻¹ represents the two-dimensional inverse Fourier transform operator, for 1≦n≦N/2
3. Let mᵤᵥ⁽ⁿ⁾= [symbol] {gᵤᵥ⁽ⁿ⁾} for 1≦n≦N/2
4. Let mᵤᵥ^{(n|N/2)}=ℑ{gᵤᵥ⁽ⁿ⁾} for 1≦n≦N/2

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} where {Q}^{( n )} = median ( {m}_{uv}^{( n )} ) \\ and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made.

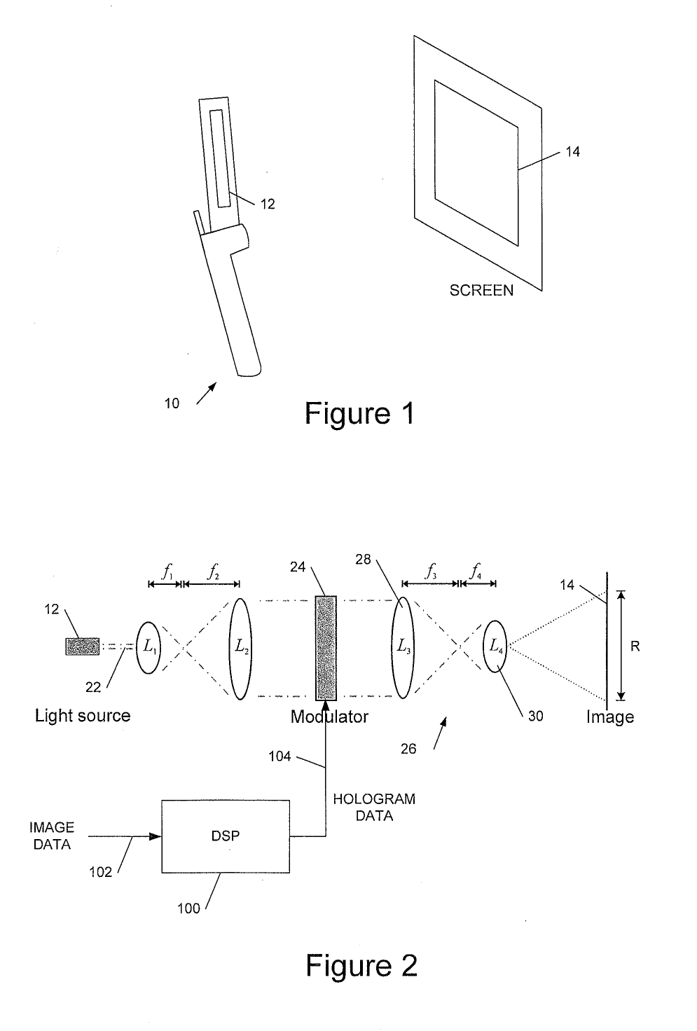

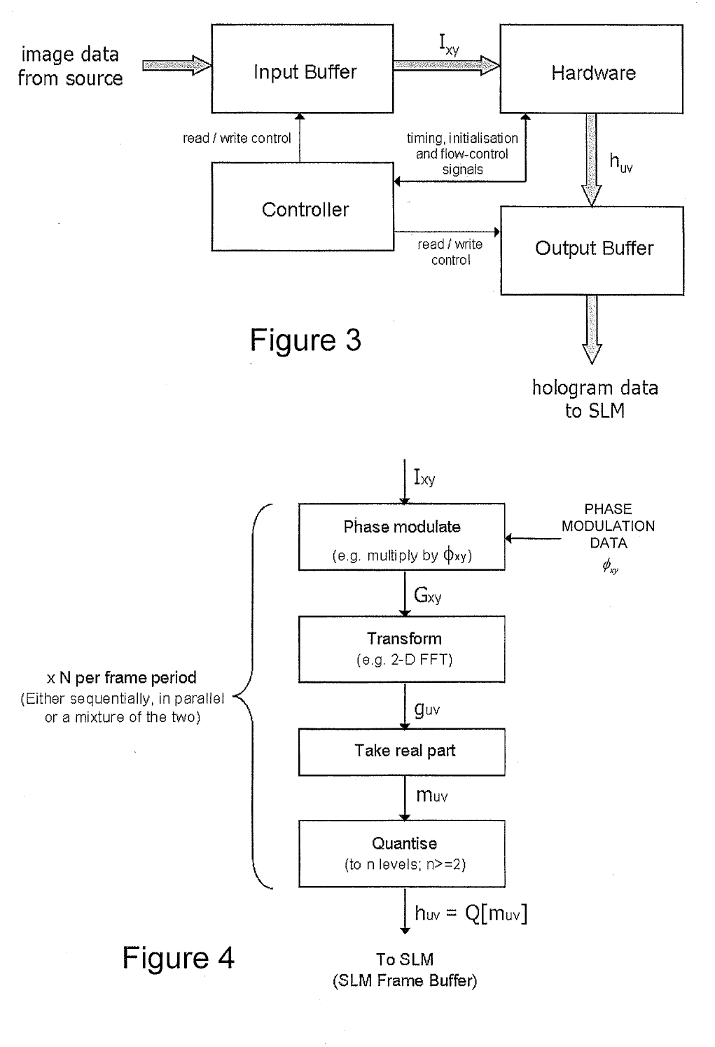

FIG. 3 shows a block diagram of an embodiment of a hardware accelerator for the holographic image display system of the module 12 of FIG. 1. The input to the system is preferably image data from a source such as a computer, although other sources are equally applicable. The input data is temporarily stored in one or more input buffer, with control signals for this process being supplied from one or more controller units within the system. Each input buffer preferably comprises dual-port memory such that data is written into the input buffer and read out from the input buffer simultaneously. The output from the input buffer shown in FIG. 1 is an image frame, labelled I, and this becomes the input to the hardware block. The hardware block, which is described in more detail using FIG. 2, performs a series of operations on each of the aforementioned image frames, I, and for each one produces one or more holographic sub-frames, h, which are sent to one or more output buffer. Each output buffer preferably comprises dual-port memory. Such sub-frames are outputted from the aforementioned output buffer and supplied to a display device, such as a SLM, optionally via a driver chip. The control signals by which this process is controlled are supplied from one or more controller unit. The control signals preferably ensure that one or more holographic sub-frames are produced and sent to the SLM per video frame period. In an embodiment, the control signals transmitted from the controller to both the input and output buffers are read/write select signals, whilst the signals between the controller and the hardware block comprise various timing, initialisation and flow-control information.

FIG. 4 shows an embodiment of a hardware block as described in FIG. 3, comprising a set of hardware elements designed to generate one or more holographic sub-frames for each image frame that is supplied to the block. In such an embodiment, preferably one image frame, I_{xy}, is supplied one or more times per video frame period as an input to the hardware block. The source of such image frames may be one or more input buffers as shown in FIG. 3. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block shown in the embodiment of FIG. 4 is to redistribute the energy of the input frame in the spatial-frequency domain, such that improvements in final image quality are obtained after performing later operations.

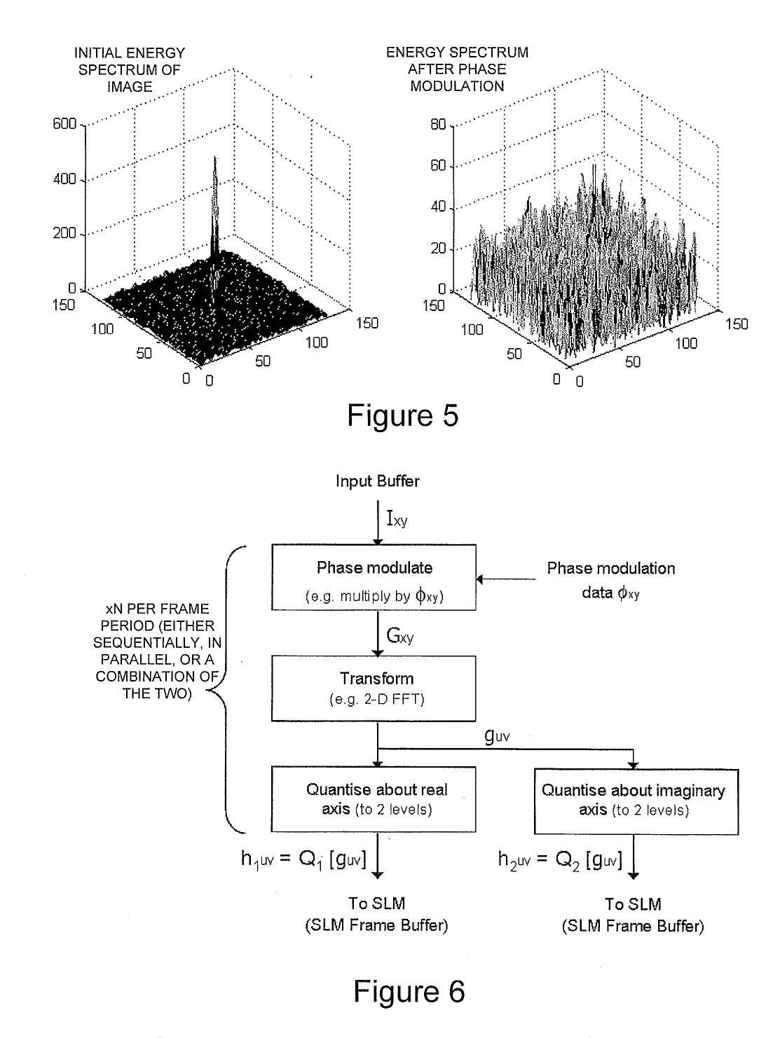

FIG. 5 shows an example of how the energy of a sample image is distributed before and after a phase-modulation stage in which a random phase distribution is used. It can be seen that modulating an image by such a phase distribution has the effect of redistributing the energy more evenly throughout the spatial-frequency domain.

The quantisation hardware that is shown in the embodiment of FIG. 4 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic sub-frame data to generate a pair of sub-frames for the output buffer, each with two phase-retardation levels. It can be shown that for discretely pixellated fields, the real and imaginary components of the complex holographic sub-frame data are uncorrelated, which is why it is valid to treat the real and imaginary components independently and produce two uncorrelated holographic sub-frames.

FIG. 6 shows an embodiment of the hardware block described in FIG. 3 in which a pair of quantisation elements are arranged in parallel in the system so as to generate a pair of holographic sub-frames from the real and imaginary components of the complex holographic sub-frame data respectively.

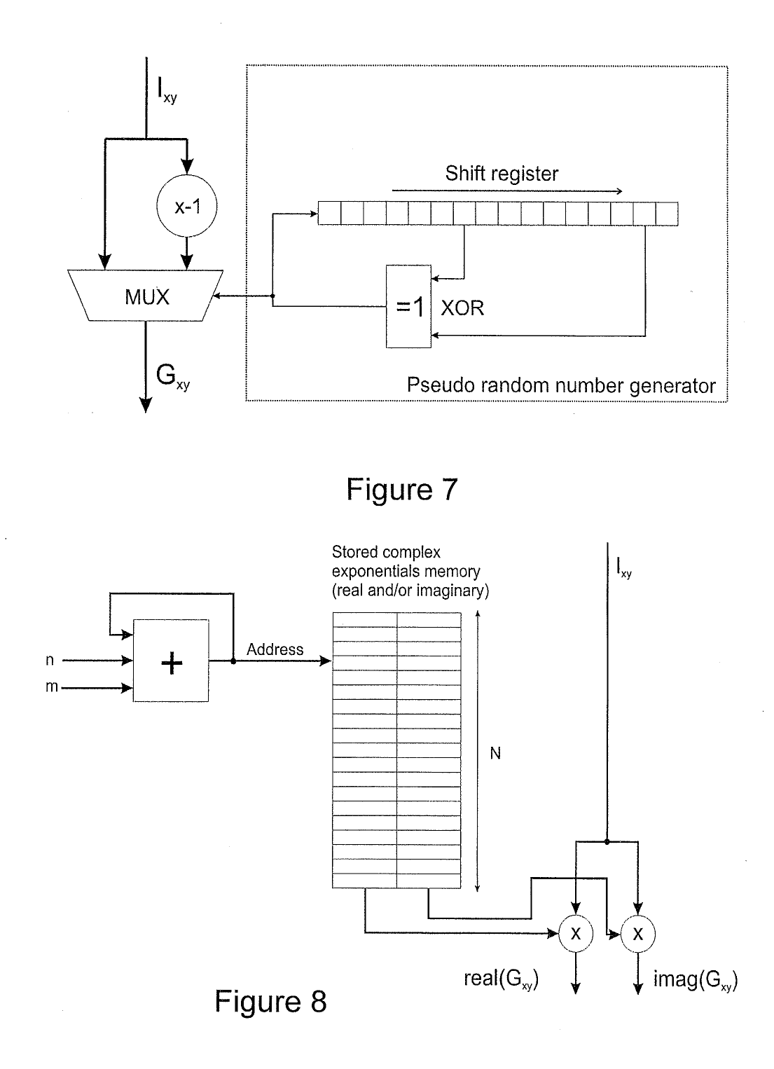

There are many different ways in which phase-modulation data, as shown in FIG. 4, may be produced. In an embodiment, pseudo-random binary-phase modulation data is generated by hardware comprising a shift register with feedback and an XOR logic gate. FIG. 7 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

FIG. 8 shows suitable hardware for such an embodiment, comprising a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic sub-frame. In another embodiment, the third input, n, is omitted. In a further embodiment, m and N are both be chosen to be distinct members of the set of prime numbers, which is a strong condition guaranteeing that the sequence of address values is truly random.

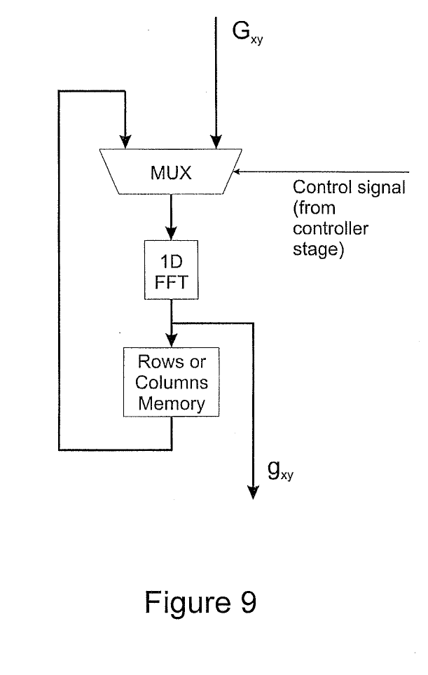

FIG. 9 shows an embodiment of hardware which performs a 2-D FFT on incoming phase-modulated image data, G_{xy}, as shown in FIG. 4. In this embodiment, the hardware required to perform the 2-D FFT operation comprises a 1-D FFT block, a memory element for storing intermediate row or column results, and a feedback path from the output of the memory to one input of a multiplexer. The other input of this multiplexer is the phase-modulated input image data, G_{xy} and the control signal to the multiplexer is supplied from a controller block as shown in FIG. 4. Such an embodiment represents an area-efficient method of performing a 2-D FFT operation.

In other implementations the operations illustrated in FIGS. 4 and/or 6 may be implemented partially or wholly in software, for example on a general purpose digital signal processor.

### Colour Holographic Image Projection Systems

Referring again to FIG. 2, the total field size of the image 14 on the screen on which it is displayed scales with the wavelength of light employed to illuminate the SLM 24, red light being defracted more by the pixels of the SLM than blue light and thus giving rise to a larger total field size. More particularly the field size is proportional to the product of the distance of the display screen from the demagnifying telescope (more particularly lens L₄) and the wavelength of light employed to illuminate the SLM, divided by the pixel size of the SLM.

Naively a colour holographic projection system could be constructed by simply employing the optical system of FIG. 2 to create three optical channels, red, blue and green superimposed to generate a colour image. However in practice this is difficult because the different colour images must be aligned on the screen. A better approach, therefore, is to create a combined beam comprising red, green and blue light and provide this to a common SLM and demagnifying optics. From the foregoing discussion, however, it will be appreciated that a problem with this approach is that the red, green and blue projected images will be of different sizes, the red image being the largest, and the blue image the smallest.

The inventors have recognised that the total field size of the displayed image depends upon the pixel size of the SLM but not on the number of pixels in the hologram displayed on the SLM. Taking into account this recognition one approach to the aforementioned problem would be scale the size of the red image down to that of the blue image, and likewise the green, so that the three image coincide on the display screen. However, this has the problem of losing resolution.

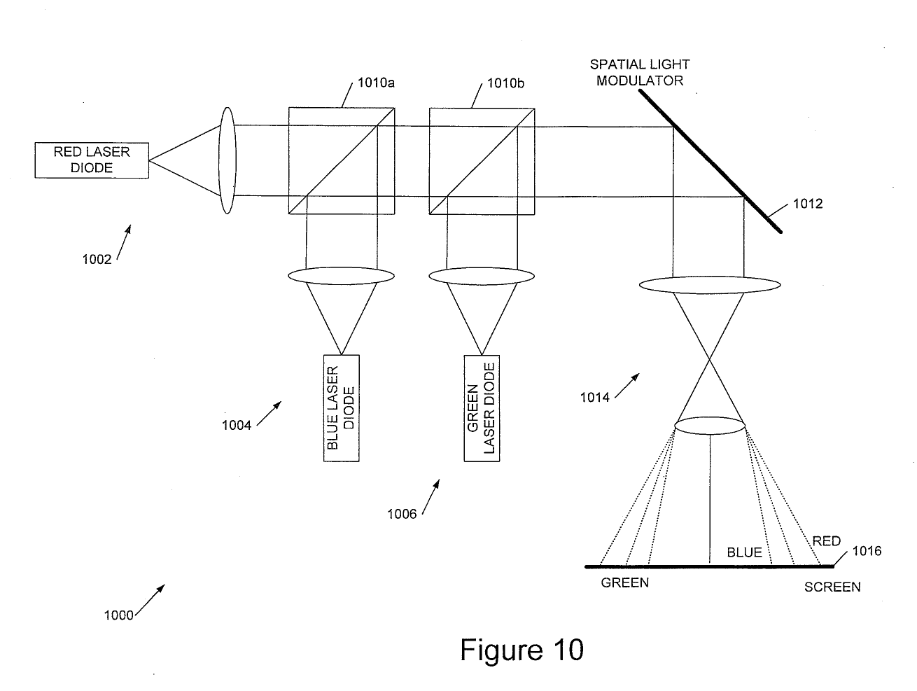

Referring now to FIG. 10, we therefore describe a preferred embodiment of a colour holographic image projection system 1000 according to the invention.

The system 1000 comprises red 1002, green 1006, and blue 1004 collimated laser diode light sources, for example at respective wavelengths of 638 nm, 532 nm and 445 nm. Each light source comprises a laser diode 1002 and, if necessary, a collimating lens and/or beam expander. Optionally the respective sizes of the beams are scaled to the respective sizes of the holograms, as described later. The red, green and blue light beams are combined in two dichroic beam splitters 1010a, b, as shown and the combined beam is provided to a reflective spatial light modulator 1012 (although in other embodiments a transmissive SLM may be employed). For example a CRL OPTO Limited (Forth Dimension Displays Limited of Scotland, UK) SXGA SLM device with a pixel pitch of 13.62 μm is suitable.

The combined optical beam is provided to demagnification optics 1014 which project the holographically generated image onto a screen 1016. As illustrated, the extent of the red field is greater than that of the blue field, determined by the (constant) SLM pixel pitch and the respective wavelengths of the illuminating light.

In operation red, green and blue fields are time multiplexed, for example by driving the laser diodes in a time-multiplexed manner, to create a full colour display.

Theoretically the demagnifying optics 1014 could be configured to demagnify by different factors for different wavelengths by, in effect, introducing controlled “chromatic” aberration. Alternatively the invention also contemplates a holographic image projection system with an electrically controllable lens in which the lens power is adjusted in accordance with the colour of light illuminating the SLM. In this way different demagnifications may be selected in synchrony with the different colours of the SLM. Preferably, however, adjustment for the different degrees of diffraction of the different colours of light by the SLM is compensated for when calculating the hologram that is to be displayed on the SLM, as described further below.

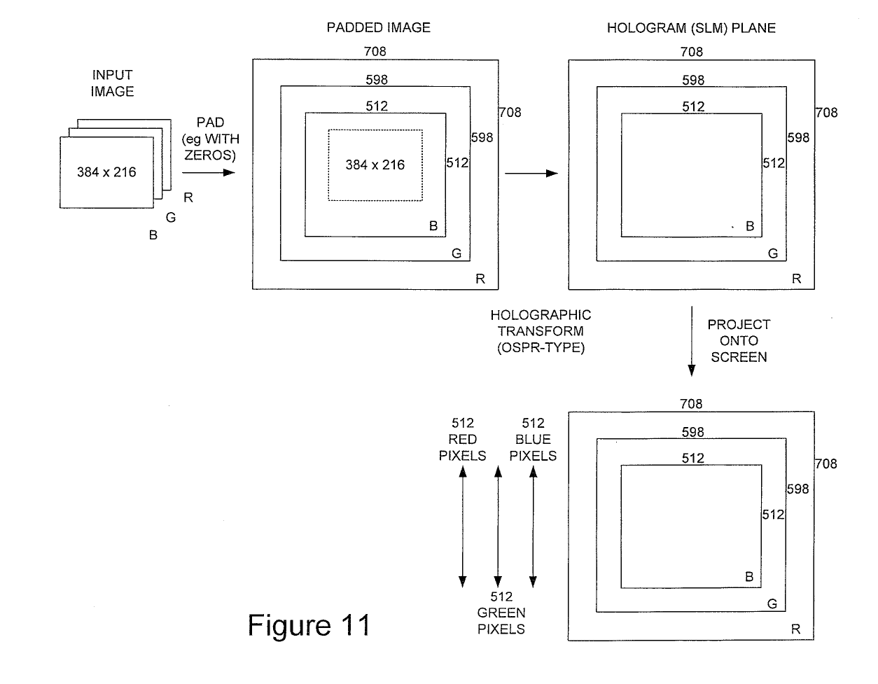

Referring to FIG. 11, this shows a first example in which an initial input image is padded with zeros in order to generate three colour planes of different spatial extents, in the example 512, 598 and 708 pixels square respectively for blue, green and red image planes. A holographic transform is then performed on these padded image planes to generate one, or more preferably a plurality (OSPR) of holograms for each sub-plane. Although the image planes from which the holograms are calculated are padded, the information in the hologram is distributed over the complete set of pixels. The hologram planes are illuminated, optionally by correspondingly sized beams, to project different sized respective fields on to the display screen. It should be recognised that although the projected fields have different sizes, this is not because different number of pixels are used in the hologram plane—the sizes of the projected fields are determined by the SLM pixel pitch, which does not vary for the three different colours. Thus it can be recognised that, in the displayed image, the pixel pitch of red, green and blue pixels is substantially the same. The increase in resolution (number of pixels along a given dimension) is in proportion to the wavelength or light employed to project the image plane. Thus for the preceding example wavelengths, the red resolution should be 638/445 times the blue resolution, and the green resolution 638/532 times the blue resolution.

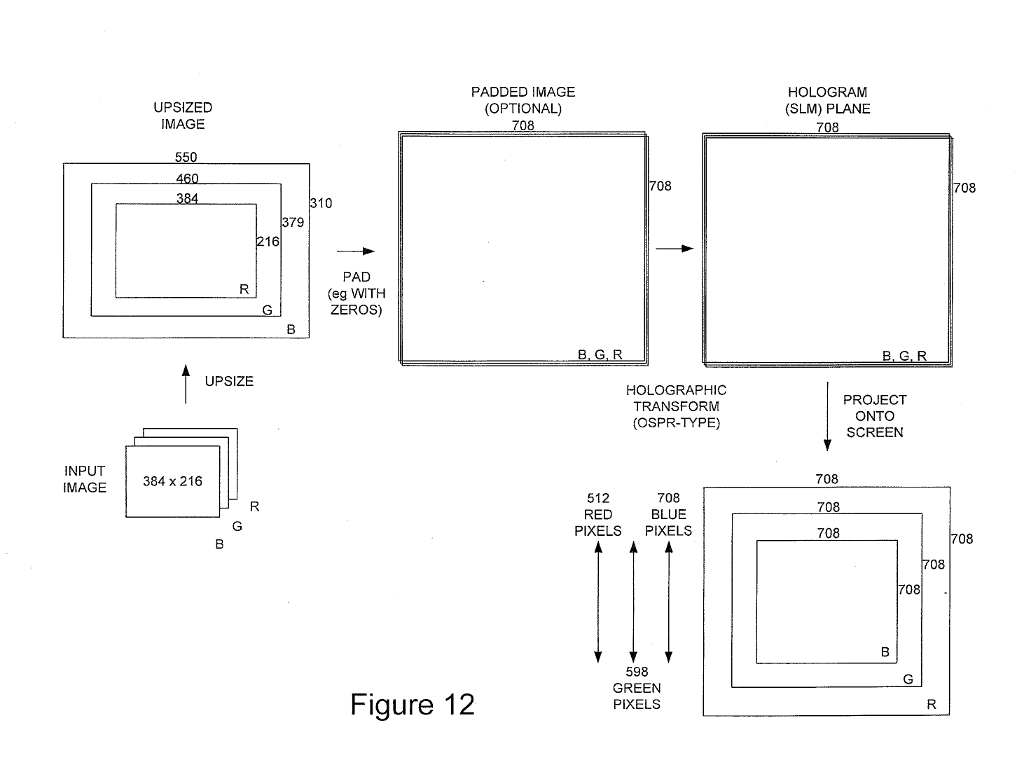

FIG. 12 shows an alternative approach in which the input image is upsized. More particularly the blue image plane is upsized in proportion to the ratio of red to blue wavelength (638/445), and the green image plane is upsized in proportion to the ratio of red to green wavelengths (638/532). The red image plane is unchanged. Optionally the upsized image may then be padded with zeros to increase the extent of the spatial image planes to a number of pixels in the SLM. In practice the upsized image may be selected to have, for the red image plane, a number of pixels equal to that available in the SLM, this effectively defining the resolution of the input image. In either case, it is often preferable to leave a little space around the edge of the SLM, for example to achieve a 90% or greater, or 95% or greater fill factor. By leaving 5% or fewer pixels around the edge of the SLM, undesirable edge effects may be reduced.

Continuing to refer to claim 12, as before the red, green and blue fields have different sizes on the display screen but, in this example, are all composed of substantially the same number of pixels. However because the blue, and green images were upsized prior to generating the hologram, or more preferably holograms, a given number of pixels, say 216 vertical pixels, in the input image occupies the same spatial extent on the display screen for red, green and blue colour planes. Thus, as illustrated, although 512 red pixels occupies the same spatial extent as 708 blue pixels, nonetheless both these correspond to the same number of pixels in the input image.

It will be appreciated that in this second alternative implementation there is the possibility of selecting an image size for the holographic transform procedure which is convenient for hardware and/or software, for example comprising a multiple of 8 or 16 pixels in each direction.

As before, it will be appreciated that the spatial extent and/or intensities of the different coloured beams may be adjusted to compensate for the different spatial extents of the displayed fields on the display screen. Optionally one or more stops may be included in the optical system to define a common boundary for the different coloured displayed fields.

Applications for the above described holographic projection system and/or optics include, but are not limited to the following: Mobile phone; PDA; Laptop; Digital camera; Digital video camera; Games console; In-car cinema; Personal navigation systems (In-car or wristwatch GPS); Displays for automobiles; Watch; Personal media player (e.g. MP3 player, personal video player); Dashboard mounted display; Laser light show box; Personal video projector (the “video iPod” idea); Advertising and signage systems; Computer (including desktop); Remote control units. A projection system and/or optics as described above may also be incorporated into an architectural fixture. In general embodiments of the above described holographic projection system and/or optics may be incorporated into any device where it is desirable to share pictures or for more than one person to view an image at once.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of projecting a colour image on a screen holographically the method comprising:
inputting colour image data comprising data for at least two colour planes of said image, a first, longer wavelength colour plane and a second, shorter wavelength colour plane;
generating data for respective first and second holograms from said first and second colour planes of said colour image data, said first hologram having a greater resolution than said second hologram; and
displaying said first and second holograms in turn on a common spatial light modulator (SLM) illuminated by light of respective said first and second wavelengths to project said colour image onto said screen; and
wherein a scaling in resolution between said first and second holograms is dependent on scaling between said first and second wavelengths such that, when projected on said screen pixels of said image generated by said first and second holograms have substantially the same pitch.

2. A method as claimed in claim 1 wherein said displaying uses common demagnifying optics to project said image.

3. A method as claimed in claim 1 further comprising padding said first colour plane data up to a spatial extent corresponding to said greater resolution prior to generating a said first hologram.

4. A method as claimed in claim 3 wherein said padded spatial extent of said first colour plane data substantially corresponds to a spatial extent, in pixels, of said SLM.

5. A method as claimed in claim 1, further comprising padding said second colour plane data to increase a spatial extent of said second colour plane prior to generating said second hologram.

6. A method as claimed in claim 1 wherein said colour image data comprises data for a third, intermediate wavelength, colour plane, wherein said hologram data generating and hologram displaying are performed on said third colour plane to project a hologram of intermediate resolution, and wherein said intermediate resolution is scaled in proportion to said third wavelength.

7. A method of projecting a colour image on a screen holographically the method comprising:
inputting colour image data comprising data for at least two colour planes of said image, a first, longer wavelength colour plane and a second, shorter wavelength colour plane;
upsizing said second colour plane in proportion to a ratio of said longer to said shorter wavelength to increase a number of image pixels in said second colour plane;
generating data for respective first and second holograms from said first and second colour planes of said colour image data; and
displaying said first and second holograms in turn on a common spatial light modulator (SLM) illuminated by light of respective said first and second wavelengths to project said colour image onto said screen; and
wherein said upsizing is such that, when projected on said screen, pixels of said first and second colour planes in said input image have substantially the same pitch.

8. A method as claimed in claim 7 wherein said upsizing comprises upsizing to substantially a spatial resolution of said SLM.

9. A method as claimed in claim 8 further comprising padding one or both of said first and second colour planes to increase a number of pixels of a said colour plane without increasing a number of image information bearing pixels.

10. A method as claimed in claim 7, wherein a resolution of said hologram data is selected to be a multiple of 8 or 16 in at least one dimension.

11. A method of generating a colour holographic image, the method employing a common spatial light modulator (SLM) to modulate at least two different colour components of said image, said SLM having a plurality of pixels modulated to display a hologram, said hologram reconstructing to display on a screen a pixellated image for each said colour component, the method comprising:
inputting data for an image to be displayed, said image data comprising data for first and second colour components of said image, said second colour component having a longer wavelength than said first colour component;
increasing a number of image information bearing pixels of said first colour component of said input image or a number of pixels of a holographic transform of said second colour component of said input image such that when displayed on said screen pixels of said first and second colour components of said input image having substantially the same size; and
generating said colour holographic image using said increased resolution component.

12. A method as claimed in claim 11 wherein said screen comprises a two-dimensional screen.

13. A method as claimed in claim 11 wherein said holographically generated image is generated using a procedure in which a plurality of holographically generated temporal subframes contribute to the image for each colour plane or component.

14. A carrier carrying computer program code to, when running, implement the method of claim 11.

15. Apparatus for projecting a colour image on a screen holographically, the apparatus comprising:
means for inputting colour image data comprising data for at least two colour planes of said image, a first, longer wavelength colour plane and a second, shorter wavelength colour plane;
means for generating data for respective first and second holograms from said first and second colour planes of said colour image data, said first hologram having a greater resolution than said second hologram; and
means for displaying said first and second holograms in turn on a common spatial light modulator (SLM) illuminated by light of respective said first and second wavelengths to project said image onto said screen; and
wherein a scaling in resolution between said first and second holograms is dependent on a scaling between said first and second wavelengths such that, when projected on said screen pixels of said image generated by said first and second holograms have substantially the same pitch.

16. Apparatus for projecting a colour image on a screen holographically, the apparatus comprising:
means for inputting colour image data comprising data for at least two colour planes of said image, a first, longer wavelength colour plane and a second, shorter wavelength colour plane;
means for upsizing said second colour plane in proportion to a ratio of said longer to said shorter wavelength to increase a number of image pixels in said second colour plane;
means for generating data for respective first and second holograms from said first and second colour planes of said colour image data;
means for displaying said first and second holograms in turn on a common spatial light modulator (SLM) illuminated by light of respective said first and second wavelengths to project said colour image onto said screen; and
wherein said upsizing is such that, when projected on said screen, pixels of said first and second colour planes in said input image have substantially the same pitch.

17. Apparatus for generating a colour holographic image, the apparatus employing a common spatial light modulator (SLM) to modulate at least two different colour components of said image, said SLM having a plurality of pixels modulated to display a hologram, said hologram reconstructing to display on a screen a pixellated image for each said colour component, the apparatus comprising;
means for inputting data for an image to be displayed, said image data comprising data for first and second colour components of said image, said second colour component having a longer wavelength than said first colour component;
means for increasing a number of image information bearing pixels of said first colour component of said input image or a number of pixels of a holographic transform of said second component of said input image such that when displayed on said screen pixels of said first and second colour components of said input image have substantially the same size; and
means for generating said colour holographic image using said increased resolution component.

18. A colour holographic image projection module, the module comprising:
light sources configured to provide collimated light beams of at least two different colours;
combining optics to combine said optical paths from said light sources into a single combined optical path;
a spatial light modulator in said combined optical path to modulate light from said light sources; and
demagnifying optics following said spatial light modulator in said combined optical path; and
wherein said illuminated light beams have different cross-sectional areas.

19. A colour holographic image projection module as claimed in claim 18 wherein lateral dimensions or areas of said illuminated light beams are substantially in proportion to a ratio of respective wavelengths of said light sources.

20. A colour holographic image projection module as claimed in claim 18 wherein amplitudes or intensities of said illuminated light beams are approximately in proportion to a ratio of respective wavelengths of said light sources.
